(19) United States
(12) Patent Application Publication
(10) Pub. No.: US 2019/0004469 A1
(43) Pub. Date: Jan. 3, 2019

(54) SHEET PUNCHING DEVICE

(71) Applicants: KABUSHIKI KAISHA TOSHIBA, Tokyo (JP); TOSHIBA TEC KABUSHIKI KAISHA, Tokyo (JP)

(72) Inventor: Shoichi DOBASHI, Nagaizumi Sunto Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/847,135

(22) Filed: Dec. 19, 2017

(30) Foreign Application Priority Data
Jul. 3, 2017 (JP) 2017-130310

(51) Int. Cl. G03G 15/00

(52) U.S. Cl. CPC G03G 15/6582

(57) ABSTRACT

A sheet punching device includes a punching unit, a cover member, an opening and closing sensor, a dust box, and a controller. The punching unit forms a punched hole in a sheet. The cover member can open and close the punching unit. The opening and closing sensor detects an open state of the cover member of the punching unit. The dust box is arranged in the punching unit and houses punch waste of the punched hole. The controller instructs continuation of a job of an image processing apparatus even if the opening of the cover member is detected by the opening and closing sensor without using the punching unit.

### CROSS-REFERENCE TO RELATED APPLICATIONS

This application is based upon and claims the benefit of priority from Japanese Patent Application No. 2017-130310, filed Jul. 3, 2017, the entire contents of which are incorporated herein by reference.

### FIELD

Embodiments described herein relate generally to a sheet punching device.

### BACKGROUND

A copying machine, a printer, and the like are provided with an image processing apparatus (an image processor, for example, a multifunction printer device, (MFP)) and a post-processing apparatus for executing a predetermined post-processing in a sheet (paper) discharge direction. Between the image processing apparatus and the post-processing apparatus, there is a device provided with a punching unit as a sheet punching device for punching a sheet.

The punching unit has a punching device forming a punched hole in the sheet with a cutter and a dust box (a receptacle) housing punch waste. If the dust box is filled with the punch waste, a front cover is opened, and the dust box is pulled out to discard the punch waste. A position of the dust box can be changed, e.g., the dust box can be pulled out from the punching unit if the image processing apparatus is in a stopped state such as during power saving or on standby.

In a case of trying to pull out the dust box during operation of the image processing apparatus, that an opening and closing cover of the punching unit is opened is detected by an opening and closing sensor and is recognized as a JAM error. “JAM display” is displayed on a display section of the image processing apparatus. The JAM error represents a determination that a sheet is jammed or stopped in a conveyance roller, a conveyance mechanism or the like in printing or conveyance of the sheet, and the image processing apparatus is stopped.

If that the opening and closing cover is opened is recognized as the JAM error, as with the JAM error caused by other reasons, a cancel operation of “JAM display” is performed to cancel the sheet clogging, stop and the like of the image processing apparatus. Then, after the cancel operation, a job restart operation is executed. In order to prioritize the safety of the image processing apparatus, an operation for removing a cause of stoppage and resuming the running becomes complicated, which impairs the convenience of operation.

### DESCRIPTION OF THE DRAWINGS

FIG. 1 is a side view of a punching unit viewed from a post-processing apparatus side according to an embodiment;

FIG. 2 is a front view of an image processing apparatus, the punching unit and the post-processing apparatus according to the embodiment;

FIG. 3 is a perspective view of a main portion when a front cover of the punching unit is opened according to the embodiment;

FIG. 4 is front view of the inside of the punching unit according to the embodiment;

FIG. 5 is a block diagram illustrating a control module of a sheet punching device according to the embodiment;

FIG. 6 is a diagram illustrating an electrical system of an image processing system according to the embodiment;

FIG. 7 is a table showing processing contents corresponding to ON and OFF of a punch waste full sensor and an opening and closing sensor according to the embodiment; and

FIG. 8 is a table showing processing contents corresponding to ON and OFF of the punch waste full sensor and the opening and closing sensor according to a conventional example.

### DETAILED DESCRIPTION

In accordance with an embodiment, a sheet punching device comprises a punching unit, a cover member, an opening and closing sensor, a dust box, and a controller. The punching unit forms a punched hole in a sheet processed by an image processing apparatus. The cover member can open and close the punching unit. The opening and closing sensor detects an open state of the cover member of the punching unit. The dust box is arranged in the punching unit and houses punch waste of the punched hole. The controller instructs continuation of a job of the image processing apparatus even if the opening of the cover member is detected by the opening and closing sensor without using the punching unit.

Hereinafter, a sheet punching device of an embodiment is described with reference to the accompanying drawings.

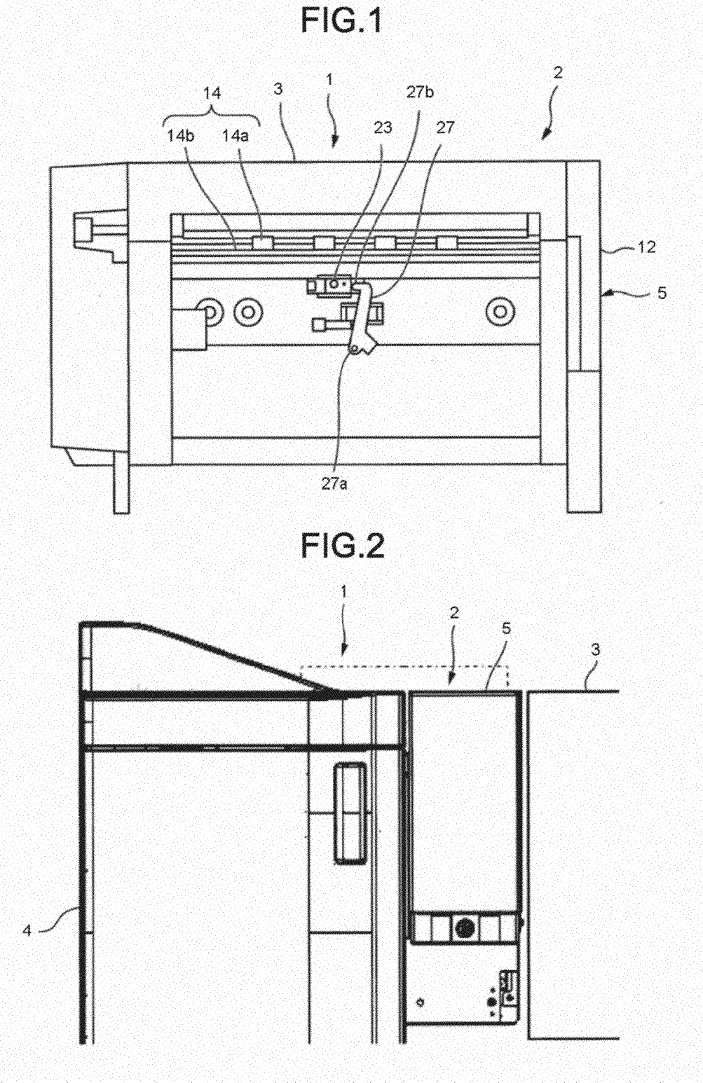

With reference to FIG. 1 to FIG. 8, a sheet punching device 2 in an image processing system 1 of an embodiment is described. The image processing system 1 arranges the sheet punching device 2 between an image processing apparatus 3 and a post-processing apparatus 4. FIG. 1 is a schematic view of the sheet punching device 2 of the image processing system 1 viewed from the post-processing apparatus 4 side. FIG. 2 is a diagram of the image processing apparatus 3, the sheet punching device 2, and the post-processing apparatus 4 viewed from the front side of the image processing system 1.

The image processing apparatus 3 executes a processing such as image formation and erasure on a sheet-like image receiving medium (hereinafter, referred to as a “sheet S”) such as a paper. A punching unit (a punch) 5 opens a punched hole with a cutter in the sheet S conveyed from the image processing apparatus 3. The post-processing apparatus 4 executes a post-processing such as sorting and stapling on the sheet S conveyed from the image processing apparatus 3.

The image processing apparatus 3 has a control panel (operation section), a scanner section, a printer section, a sheet feed section, and a sheet discharge section. The control panel is provided with various keys or a touch panel for receiving operations by a user. The control panel receives input relating to a type of a post-processing on the sheet S. The control panel can select a sorting mode in which a sorting processing is executed, a stapling mode in which a stapling processing is executed, and a non-sorting mode in which the sorting processing and the stapling processing are not executed. The control panel has a punching mode operation section 7 for selecting a punching mode to open the punched hole in the sheet S (refer to FIG. 5). In addition, the image processing apparatus 3 includes a display section 8 which displays an open state of a front cover 12 as a cover member of the punching unit 5.

The scanner section includes a reading section that reads image information of a copied object. The scanner section sends the read image information to the printer section. The printer section forms an output image with a developer such as a toner based on image information transmitted from the scanner section or an external device. The printer section applies heat and pressure to the toner image transferred onto the sheet S to fix the toner image on the sheet S.

The sheet feed section supplies the sheets S one by one to the printer section in accordance with a timing at which the printer section forms the toner image. The sheet discharge section conveys the sheet S discharged from the printer section to the post-processing apparatus 4 after the punching unit 5 opens a punched hole. The image processing apparatus 3 has a controller 10 controlling punching of the punched hole in the sheet S at the punching unit 5 by operation of the punching mode operation section 7.

Next, the sheet punching device 2 is described.

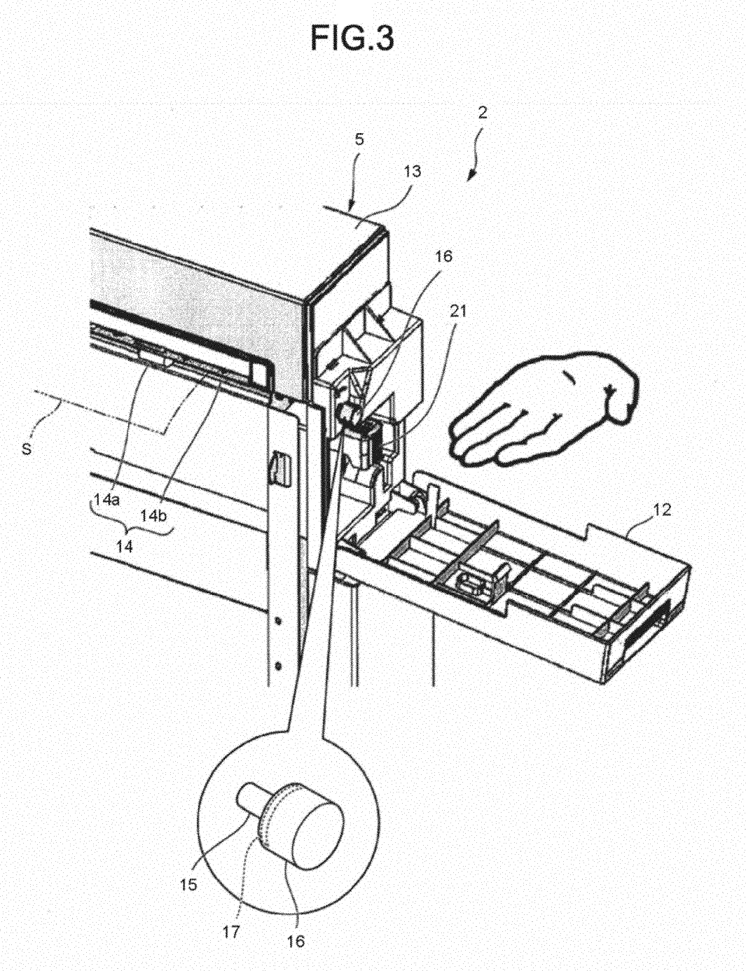

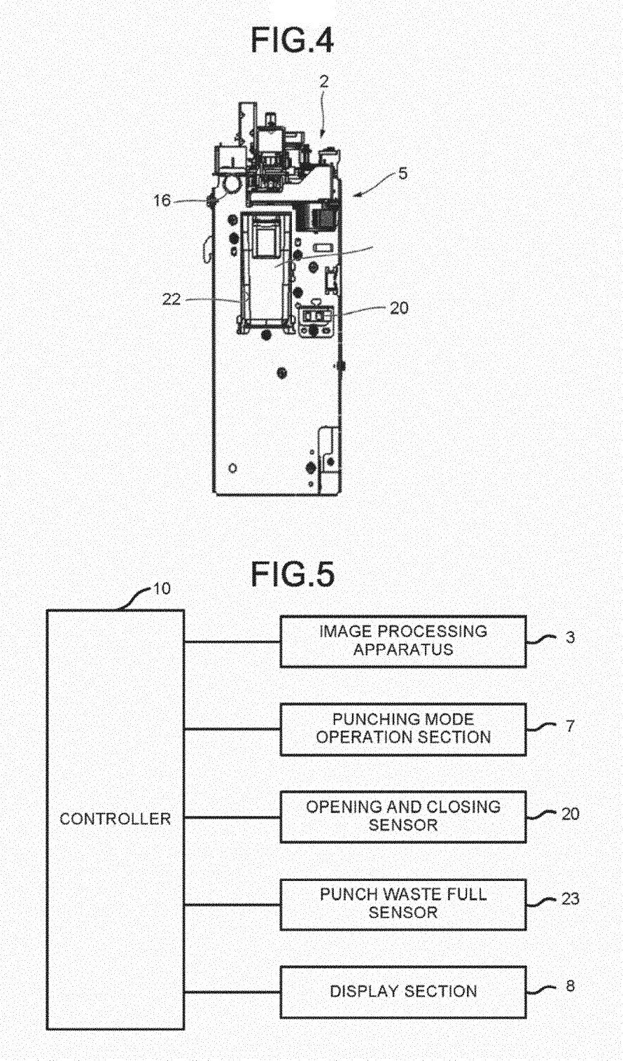

As shown in FIG. 1 and FIG. 2, the punching unit 5 of the sheet punching device 2 is arranged between the image processing apparatus 3 and the post-processing apparatus 4. FIG. 3 is a diagram illustrating the state in which the front cover 12 as the cover member of the punching unit 5 is opened. The front cover 12 is arranged to be openable and closable around a hinge provided at the lower side portion of a housing 13 of the punching unit 5. FIG. 4 is a diagram illustrating the internal structure of the punching unit 5 excluding the front cover 12 and an inner cover.

In FIG. 3, at the top of the punching unit 5, a conveyance roller 14 which conveys the sheet S discharged from the image processing apparatus 3 to the post-processing apparatus 4 is arranged. The punching unit 5 internally forms the punched hole in the sheet S and discharges it through the conveyance roller 14 to the post-processing apparatus 4. In the conveyance roller 14, a driving roller 14a and a driven roller 14b face each other. A plurality of the driving rollers 14a is supported by a shaft 15 at predetermined intervals. The driven roller 14b having a rod-like long axis is supported while facing and abutting against the driving roller 14a. The sheet S sandwiched between the driving roller 14a and the driven roller 14b is conveyed by a driving motor (not shown).

One end of the shaft 15 of the driving roller 14a protrudes towards the front cover 12 side and is connected to an operation knob (an operation rotator) 16. The operation knob 16 is included in the operation section. A torque limiter 17 is mounted between the shaft 15 and the operation knob 16. In a normal state, the operation knob 16 rotates integrally with the shaft 15 of the driving roller 14a to discharge the sheet S by sandwiching the sheet S with the driven roller 14b. If a hand of a user touches the operation knob 16 and a load exceeding a certain load is applied, the torque limiter 17 slips to prevent rotation of the operation knob 16 and only the shaft 15 of the driving roller 14a continues rotation. An idle torque of the operation knob 16 is smaller than a torque of the drive motor to avoid step-out of the drive motor.

If the driving motor of the shaft 15 is stopped according to an instruction of the image processing apparatus 3 due to a JAM error of the sheet S, the operation knob 16 rotates the driving roller 14a forward and reversely by manual operation. By the forward and reverse rotation of the operation knob 16, the sheet S stopped due to the JAM error is fed in either front or rear direction. If the JAM error of the sheet S occurs, since the punching unit 5 is arranged at a boundary between the image processing apparatus 3 and the post-processing apparatus 4, the punching unit 5 cannot automatically discharge the sheet S and cancel the JAM error. In this case, by manually rotating the operation knob 16 provided in the punching unit 5, the sheet S sandwiched through the conveyance roller 14 is discharged in either the front or rear direction, and the JAM error can be canceled.

Instead of the torque limiter 17, a one-way clutch may be arranged between the shaft 15 and the operation knob 16. In this case, the sheet S can only be discharged in one direction, for example, to the post-processing apparatus 4 side. In the case of using the torque limiter 17, the operation knob 16 can convey the sheet S in a feed direction and a return direction.

In FIG. 4, an opening and closing sensor 20 is arranged obliquely below the operation knob 16 in the punching unit 5. The opening and closing sensor 20 detects that the front cover 12 is opened from one side of the punching unit 5. The opening and closing sensor 20 may be a touch sensor that contacts with the front cover 12 and detects a separated state. The opening and closing sensor 20 may be a light sensor having a light emitting portion and a light receiving portion. If the opening and closing sensor 20 detects opening or closing of the front cover 12, information is transmitted to the controller 10 provided in the image processing apparatus 3.

In FIG. 3 and FIG. 4, a dust box 21 is detachably arranged in a storage space 22 between the operation knob 16 and the opening and closing sensor 20. At the upper side of the dust box 21, a cutter (not shown) which forms the punched hole in the sheet S is arranged. The dust box 21 is a box with a top opening that receives the punch waste of a hole formed in the sheet S by the cutter. The punch waste can be dropped into the dust box 21 and stored until the upper opening. If the punch waste accumulates in the dust box 21, the front cover 12 can be opened and the dust box 21 can be drawn out to discard the punch waste.

In FIG. 1, at the side of the dust box 21, a punch waste full sensor 23 for detecting that the dust box 21 is full of the punch waste until the upper opening is arranged. The punch waste full sensor 23 is composed of light sensors having, for example, the light emitting portion and the light receiving portion at both sides of the upper opening of the dust box 21. Windows are formed at both sides of the upper opening of the dust box 21, and the light emitting portion and the light receiving portion are arranged at the outside thereof, respectively. If the punch waste in the dust box 21 accumulates until the upper opening, an optical path of the punch waste full sensor 23 is blocked and it becomes ON, and that the dust box is full of the punch waste can be detected. The information is transmitted to the controller 10 provided in the image processing apparatus 3.

At one side of the dust box 21, a detection lever 27 for detecting removal of the dust box 21 is arranged to be capable of swinging around a spindle 27a. The detection lever 27 is preferably energized to one side of a swing range by an elastic member such as a coil spring. For example, in a state in which the dust box 21 is housed in the storage space 22, the detection lever 27 resists an energization force and a detection section 27b at the tip thereof is out of the optical path by a stopper (not shown) between the light emitting and receiving portions of the punch waste full sensor 23 to be held. If the dust box 21 is pulled out from the storage space 22, the detection lever 27 is separated by the stopper and the detection section 27b enters the optical path of the punch waste full sensor 23. As a result, the optical path of the punch waste full sensor 23 is blocked and the punch waste full sensor 23 becomes ON. The information is also transmitted to the controller 10.

Therefore, it is possible to detect both the detection of the fullness of the dust box 21 and the extraction of the dust box 21 by one punch waste full sensor 23. There is no need to distinguish between both detection signals. In either case, a job (i.e., a current job operation performed by the image processing apparatus, such as a job which is already underway when the sensor detects that the cover is open) can be continued without using the punching mode. That is, when a job is already underway, the image processing apparatus maintains its ongoing performance of the job. Both detection signals can be distinguished by the user depending on whether the dust box 21 is housed in or pulled out of the storage space 22 of the punching unit 5.

FIG. 5 is a diagram illustrating the control module of the punching unit 5 provided in the image processing apparatus 3 according to the present embodiment. The controller 10 is electrically connected to the image processing apparatus 3, the punching mode operation section 7, and the display section 8. The controller 10 is also electrically connected to the opening and closing sensor 20 for detecting the opening and closing of the front cover 12, and to the punch waste full sensor 23 in the sheet punching device 2.

In the present embodiment, the image processing apparatus 3 determines whether or not the processing of the sheet S can be continued according to relationship between ON and OFF of the opening and closing sensor 20 of the front cover 12 and ON and OFF of the punch waste full sensor 23. If the punching mode in FIG. 7 (a) is used, the operation of the image processing apparatus 3 is prevented in the open state of the front cover 12 to ensure safety. This is displayed on the display section 8 as “JAM display”. On the other hand, if the punching mode in FIG. 7 (b) is not used, there is no problem even if the operation of the image processing apparatus 3 is continued with the front cover 12 in the open state. This is displayed on the display section 8 as “JOB continuation”.

On the other hand, if the front cover 12 is closed, there is no problem even if the operation of the image processing apparatus 3 is continued both in the case of using the punching mode and in the case of not using it. It is displayed on the display section 8 as “JOB continuation”. However, in the case of using the punching mode, if the front cover 12 is closed and the dust box 21 is full, “full” is displayed on the display section 8 and the operation of the image processing apparatus 3 is stopped. This prevents the punch waste from spilling over the dust box 21. There may be a time lag in stopping the operation of the image processing apparatus 3 after fullness is detected. The operation of the image processing apparatus 3 may be stopped after the completion of the punching operation of the sheet S in synchronization with the fullness detection of the dust box 21. The “JAM display” may be displayed instead of the “full” at the time of stopping the operation of the image processing apparatus 3.

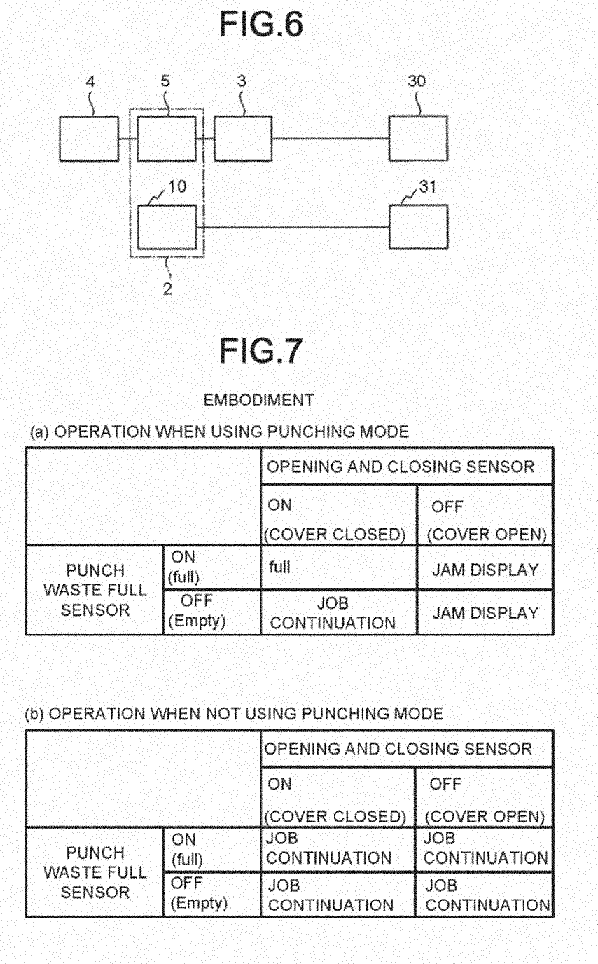

In the present embodiment, as shown in FIG. 6, the operations of the image processing apparatus 3, the post-processing apparatus 4, and the punching unit 5 are controlled by a first power supply device 30 with a voltage of 24 V, for example. The opening and closing sensor 20 provided in the punching unit 5 is operated by a second power supply device 31 with a voltage of 5 V which is a system different from the first power supply device 30, for example. The first power supply device 30 controls the operations of the jobs of the image processing apparatus 3, the post-processing apparatus 4, and the punching unit 5. The operation of sheet punching device 2 is controlled by a power supply of two systems including the first power supply device 30 for operating the punching unit 5 and the second power supply device 31 for controlling the opening and closing sensor 20 of the front cover 12. If the front cover 12 of the punching unit 5 is opened, a circuit of the second power supply device 31 is cut off and the job operation by the first power supply device 30 can be continued.

The sheet punching device 2 according to the present embodiment has the above-mentioned constitution, and the function thereof is described below.

In the operating state of the image processing system 1, in the punching mode, the front cover 12 of the punching unit 5 is closed (ON). The sheet S processed in the image processing apparatus 3 is conveyed to the punching unit 5 and the punched hole is opened by the cutter. The punch waste falls into the dust box 21 at the lower side. The sheet S opened with the punched hole is conveyed to the post-processing apparatus 4 through the conveyance roller 14 to be subject to a post-processing. If the dust box 21 becomes full, the punch waste full sensor 23 becomes ON and the fullness information is sent to the controller 10 of the image processing apparatus 3.

As shown in FIG. 7(a), if the punch waste full sensor 23 is not full (OFF) in the use state of the punching mode, “JOB continuation” is displayed on the display section 8. The punch waste full sensor 23 detects fullness (ON), the display section 8 displays “full”, and then the operation of the image processing apparatus 3 stops.

If the punching mode shown in FIG. 7 (b) is not used, “JOB continuation” is displayed in a state in which the punch waste full sensor 23 is not full (OFF). Even if the punch waste full sensor 23 detects fullness (ON), since there is no punch waste, there is no need to stop the operation of the image processing apparatus 3 and “JOB continuation” is displayed.

If the front cover 12 is opened as shown in FIG. 3 in order to discard the punch waste in the dust box 21, the opening and closing sensor 20 becomes OFF. In the use state of the punching mode in FIG. 7 (a), the display section 8 displays “JAM display” whether the punch waste full sensor 23 is ON (full) or OFF (not full). The image processing apparatus 3 and the punching unit 5 are stopped. In this state, the dust box 21 can be removed from the storage space 22 and the punch waste can be discarded.

In a state in which the punching mode shown in FIG. 7(b) is not used, during the “JOB continuation”, there is a case in which the dust box 21 is tried to be pulled out with the front cover 12 opened. At this time, the conveyance roller 14 and the operation knob 16 are in a rotation state. If a hand of the user erroneously touches the operation knob 16, a rotational resistance load is applied to the operation knob 16. If a load exceeding a predetermined value is applied to the operation knob 16 with respect to the rotating conveyance roller 14 and the shaft 15, the rotation of the operation knob 16 is prevented or the operation knob 16 is idle by an action of the torque limiter 17. Therefore, the hand of the user can be prevented from injured by the operation knob 16, and safety is secured.

If “JAM display” is displayed in the use of the punching mode, the conveyance roller 14 and the operation knob 16 are stopped. In this state, by manually rotating the operation knob 16, it is possible to feed the jammed sheet S in the forward and reverse directions. It is possible to cancel the jam.

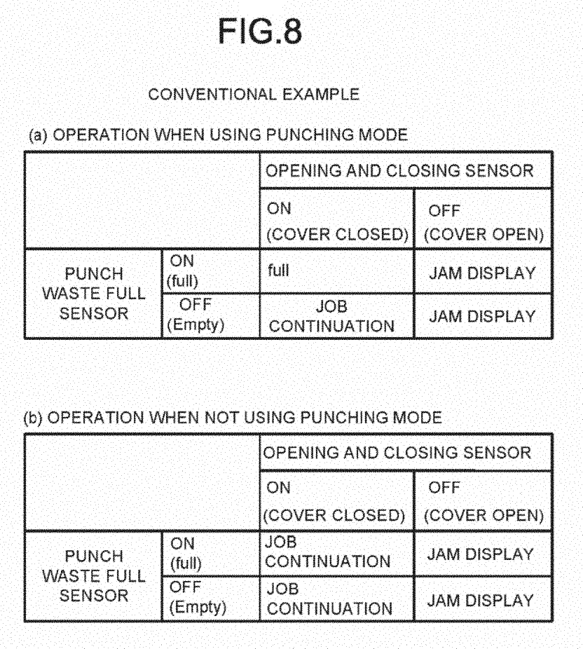

FIG. 8 is a table showing the operation of the conventional example. The operation of the embodiment shown in FIG. 7 is described in comparison with the conventional example. In the state of not using the punching mode, in the conventional example in FIG. 8, “JAM display” is displayed if the front cover 12 is opened whether the dust box 21 is full or not full. The image processing apparatus 3 and the post-processing apparatus 4 are stopped. Therefore, in order to restart the operation, it is necessary to cancel the jam and restart the job. In the present embodiment, in a state in which the punching mode is not used, “JOB continuation” can be maintained even if the front cover 12 is opened. The image processing apparatus 3 and the post-processing apparatus 4 can be kept in an operating state. In this state, the position of the dust box 21 is moved so that the dust box 21 can be extracted and the punch waste can be discarded.

According to at least one embodiment described above, even if the front cover 12 is opened without using the punching mode, “JOB continuation” is displayed and the job can be continued. Since it is not the JAM error (“JAM display”) as in the conventional example, the jam cancel operation and the job resuming operation are unnecessary, thereby simplifying the operation. It is possible to safely extract the dust box 21 and discard the punch waste even in operation of the image processing apparatus 3 and the post-processing apparatus 4, thereby improving convenience.

Even if the hand of the user touches the rotating operation knob 16 with the front cover 12 opened in the “JOB continuation” state, safety can be ensured by idling the operation knob 16 with the torque limiter 17.

In the other embodiments of the present embodiment below, the same or similar components and members as those of the above-described embodiment are described with the same reference numerals.

The image processing apparatus 3 may include two fixing sections, i.e., a fixing section for fixing and a fixing section for decoloring. Further, in at least one embodiment, the image processing apparatus further allows for image erasing as well as image formation.

In the embodiment described above, it can be applied to each job such as non-sorting, sorting, stapling, saddling, etc. as a job without using the punching mode. However, the present embodiments are not limited to these jobs, and are configured to perform job(s) other than a job of operating the punching unit 5.

In the above-described embodiment, the torque limiter 17 and the one-way clutch are included in an idling mechanism.

In the above embodiment, both the fullness of the punch waste in the dust box 21 and the extraction of the dust box 21 are detected by one punch waste full sensor 23. However, in some embodiments, instead of this, the extraction of the dust box 21 from the storage space 22 may be detected by another sensor. In this case, both fullness and extraction can be distinguished and detected.

The open state of the front cover 12 may be displayed on the display section 8. Attention can be drawn by displaying that the front cover 12 is open to the user in the JOB continuation or stopping state of the image processing apparatus 3 and the post-processing apparatus 4.

According to at least one embodiment described above, by including the controller 10 for detecting the opening of the front cover 12 and instructing to continue the job without using the punching unit 5, the operation becomes simple and the convenience can be improved.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A sheet punching device, comprising:
a punching unit configured to form a punched hole in a sheet;
a cover member configured to open and close the punching unit;
an opening and closing sensor configured to detect at least an open state of the cover member;
a dust box, arranged in the punching unit, configured to house waste generated by forming the punched hole; and
a controller configured to continue a job of an image processing apparatus in a case of detecting the opening of the cover member by the opening and closing sensor without using the punching unit.

2. The sheet punching device according to claim 1, further comprising:
a conveyance roller configured to convey the sheet in the punching unit;
a rotator which is configured to rotate integrally with the conveyance roller; and
an idling mechanism configured to idle the conveyance roller when a load is applied to the rotator.

3. The sheet punching device according to claim 2, wherein
the idling mechanism is a torque limiter or a one-way clutch.

4. The sheet punching device according to claim 2, wherein
a second power supply device to operate the opening and closing sensor is different from a first power supply device to operate the conveyance roller, and
the second power supply device is set to a voltage lower than the first power supply device.

5. The sheet punching device according to claim 3, wherein
the second power supply device to operate the opening and closing sensor is different from the first power supply device to operate the conveyance roller, and
the second power supply device is set to a voltage lower than the first power supply device.

6. A sheet punch system, comprising:
an image processor configured to process a sheet and to communicate with a controller;
a punch configured to form a hole in the sheet;
a cover configured to open and close the punch; and
a sensor configured to detect whether the cover is open or closed,
wherein when the sensor detects that the cover is open, the controller instructs the image processor to maintain a current operation.

7. The sheet punch system of claim 6, further comprising:
a receptacle configured to store waste generated when the punch forms the hole.

8. The sheet punch system of claim 7, further comprising a second sensor configured to determine whether the receptacle is full.

9. The sheet punch system of claim 8, wherein the second sensor is further configured to determine a position of the receptacle.

10. A sheet punching processing method, comprising:
forming, by a punch, a punched hole in a sheet processed by an image processing apparatus;
opening and closing a cover of the punch;
detecting, by a sensor arranged with the punch, whether the cover is in an open state or a closed state; and
when the sensor determines that the cover is in the open state, causing the image processing apparatus to continue a current operation without operation of the punch.

11. The sheet punching processing method according to claim 10, further comprising:
conveying the sheet to the punch by a conveyance roller;
causing the conveyance roller to idle in response to detection of a load on a portion of the image processing apparatus.

12. The sheet punching processing method according to claim 11, further comprising limiting torque applied to the portion of the image processing apparatus.

13. The sheet punching processing method according to claim 11, further comprising:
supplying power to the sensor by a first power supply device, and
supplying power to the conveyance roller by a second power supply device,
wherein a voltage of the second power supply device exceeds a voltage of the first power supply device.

14. The sheet punching processing method according to claim 10, further comprising:
sensing, by another sensor, at least one of a fullness state or a position of a receptacle configured to store waste generated by the punch.
